(19) United States
(12) Patent Application Publication
(10) Pub. No.: US 2024/0218273 A1
(43) Pub. Date: Jul. 4, 2024

(54) ZINC-BASED SULFUR COMPOUND SCAVENGER WITH REDUCED SOLIDS DEPOSITION

(71) Applicant: Baker Hughes Oilfield Operations LLC, Houston, TX (US)

(72) Inventors: Scott Lehrer, The Woodlands, TX (US); Zhengwei Liu, Houston, TX (US); Philippe Prince, Pearland, TX (US); Jagrut Jani, Sugar Land, TX (US)

(73) Assignee: Baker Hughes Oilfield Operations LLC, Houston, TX (US)

(21) Appl. No.: 18/091,367

(22) Filed: Dec. 30, 2022

(51) Int. Cl. C10G 75/04; C02F 1/28; C02F 5/08; C09K 8/532; C09K 8/54; C10G 29/10

(52) U.S. Cl. CPC C10G 75/04; C02F 1/281; C02F 5/08; C09K 8/532; C09K 8/54; C10G 29/10; C02F 2103/10; C09K 2208/20; C10G 2300/202; C10G 2300/207

(57) ABSTRACT

Certain zinc-based scavengers can scavenge sulfur compounds from fluids containing one or more hydrocarbons, water and the sulfur compound, but may leave deposits of insoluble zinc sulfide (ZnS) which can be problematic. When the zinc-based scavengers are used together with at least one zinc sulfide deposition preventer, deposition of zinc sulfide can be reduced or eliminated. The sulfur compound may be hydrogen sulfide (H₂S). Suitable zinc-based sulfur compound scavengers include, but are not necessarily limited to, a zinc carboxylate, a tetramine zinc carbonate, zinc carbonate, zinc ammonium carbonate, zinc chelates, and/or zinc lignosulfonate. Suitable zinc sulfide deposition preventers include, but are not necessarily limited to, sodium salts of a phosphorous-based polymer, polymeric ammonium salts, acrylic sulfonate non-ionic terpolymers, and/or modified acrylic acid polymers.

### TECHNICAL FIELD

The present invention relates to methods for scavenging sulfur compounds such as H₂S, from fluids containing hydrocarbon and water, such as mixed production, and more particularly relates to methods for scavenging sulfur compounds from fluids containing hydrocarbon and water, where such scavenging may undesirably cause zinc sulfide deposits.

### BACKGROUND

In the drilling, completions, production, transport, storage, and processing of crude oil and natural gas, including waste water associated with crude oil and gas production, and in the storage of residual fuel oil, contaminants are often encountered. Such contaminants can be sulfur-containing and may include, but are not necessarily limited to, hydrogen sulfide (H₂S), mercaptans, and/or sulfides. The presence of H₂S, sulfides, and mercaptans is extremely objectionable because they are an acute health hazard and often highly corrosive. Still another reason that H₂S and mercaptans are undesirable is that they have highly noxious odors. The odors resulting from mercaptans are detectable by the human nose at comparatively low concentrations and are well known. For example, mercaptans in very small concentrations are used to odorize natural gas and used as a repellant by skunks and other animals.

Further, other of these contaminants in liquid hydrocarbons, hydrocarbon gas and/or mixed systems of hydrocarbons and water, including mixed production systems may cause various health, safety and environmental (HSE) concerns and/or corrosion issues during the production, storage, transportation and processing of oil and gas.

To eliminate these contaminants and potentially harmful species, various scavenger systems have been developed in the art. However, many of these systems have limitations, including, but not necessarily limited to, low reactivity and therefore low efficiency, containing atypical components or elements that may adversely affect fuel or fluid quality or are refinery catalyst poisons, or may present toxicity concerns themselves and/or as the consequent reaction products. Typical components include metals and certain amines such as monoethanolamine and methylamine as non-limiting examples. These materials limit the applicability of scavengers in refinery applications and thus are one of the drivers for why new non-triazine scavengers are needed.

It should be understood that nearly all scavenging systems for removing H₂S, mercaptans and/or sulfides from oil-based systems such as crude oil, oil slurries, asphalt, and the like, cannot be assumed to work in mixed production systems or dry and/or wet hydrocarbon gas systems or other mixed systems containing some water. A mixed production system may contain a hydrocarbon gas, such as natural gas. As defined herein “hydrocarbon” refers to naturally occurring hydrocarbons recovered from subterranean formations which are not necessarily limited to molecules having only hydrogen and carbon and which may include heteroatoms including, but not necessarily limited to oxygen, nitrogen, and sulfur.

Zinc-based H₂S scavengers are very effective for petroleum industry applications but can have drawbacks. One possible drawback is the formation of a zinc sulfide (ZnS) reaction product which tends to migrate to an aqueous phase and can cause deposition problems in some applications. That is, while zinc-containing H₂S scavengers are very effective and fast-acting, under some conditions they generate a solid ZnS byproduct which limits their use in oil and gas applications due to the solid ZnS blocking flowlines, pipelines, and other conduits.

It would be desirable if methods and/or compositions could be devised that would, reduce or eliminate the tendency of zinc-based sulfur compound scavengers to undesirably deposit ZnS solids.

### SUMMARY

There is provided, in one form, a method for scavenging a sulfur compound from a fluid comprising a hydrocarbon, water, and the sulfur compound that is H₂S, sulfide, and/or bisulfide. The method includes injecting at least one zinc-based sulfur compound scavenger into the fluid in an amount effective to at least partially scavenge the sulfur compound from the fluid and injecting at least one zinc sulfide deposition preventer into the fluid in an amount effective to at least partially prevent the deposition of zinc sulfide from the fluid. Injecting the at least one zinc-based sulfur compound scavenger and injecting at least one zinc sulfide deposition preventer can occur in any order or simultaneously.

There is additionally provided in a different non-limiting embodiment a sulfur compound scavenged fluid that includes a hydrocarbon, water, the sulfur compound which is H₂S, sulfide, and/or bisulfide, at least one zinc-based sulfur compound scavenger in an amount effective to at least partially scavenge the sulfur compound from the fluid, and at least one zinc sulfide deposition preventer into the fluid in an amount effective to at least partially prevent the deposition of zinc sulfide from the fluid.

### BRIEF DESCRIPTION OF THE DRAWINGS

FIG. 1 is a photograph of three bottles containing 50 vol % water and 50 vol % oil taken from a well separator and containing 700 ppm of a zinc-based sulfur compound scavenger, where the bottle of Example 11 contained no zinc sulfide deposition preventer, the bottle of Example 12 contained 500 ppm zinc sulfide deposition preventer, and the bottle of Example 13 contained 1000 ppm zinc sulfide deposition preventer.

### DETAILED DESCRIPTION

It has been discovered that zinc sulfide deposition from the use of a zinc-based sulfur compound scavenger, such as to scavenge H₂S from mixed production in one non-limiting embodiment, can be prevented or reduced by co-injection with a zinc sulfide deposition preventer.

The fluids treated with a zinc-based sulfur compound scavenger include a hydrocarbon, water, and a sulfur compound, which sulfur compound includes, but is not necessarily limited to H₂S, sulfide, and/or bisulfide. It will be understood that the term “zinc-based sulfur compound scavenger” will be used interchangeably herein with “zinc-based H₂S scavenger”. While a major concern is the scavenging of H₂S, it will be appreciated that the same compounds can scavenge other sulfur species including, but not limited to, sulfides and bisulfides. Further, “mixed production” as defined herein is a fluid that contains a hydrocarbon, such as crude oil and/or condensate, and water, such as brine or fresh water, and associated gas, if any.

The method is not limited to any order of introduction of the zinc-based sulfur compound scavenger or zinc sulfide deposition preventer into the fluid being treated. To be explicit, these components may be introduced as a single formulation, or by co-injection, or the scavenger is introduced first and the preventer second, or the preventer is introduced first and the scavenger second. In some non-limiting embodiments, it may be less advantageous to inject the scavenger first and the preventer second. It may be likely that the preventer would work better if it is added at the same time or before the formation of zinc sulfide due to scavenger addition.

Suitable zinc-based sulfur compound scavengers include, but are not necessarily limited to, a zinc carboxylate, a tetramine (2+) zinc carbonate, zinc carbonate, a zinc ammonium carbonate, a zinc chelate, and/or a zinc lignosulfonate. Suitable zinc chelates include, but are not necessarily limited to, zinc ethylenediaminetetraacetic acid (EDTA), zinc 2,3-dimercaptopropanesulfonic acid (DMPS), zinc thiamine tetrahydrofurfuryl disulfide (TTFD), zinc TSQ (6-methoxy-8-toluenesulfonamido-quinoline), and combinations of these.

Suitable zinc sulfide deposition preventers include, but are not necessarily limited to, sodium salts of a phosphorous-based polymer, polymeric ammonium salts, acrylic sulfonate non-ionic terpolymers, and/or modified acrylic acid polymers. The phosphorous-based polymer may include, but is not necessarily limited to, polymers of 2-propenoic acid, polymers with sodium ethenesulfonate, disodium salt-initiated polymers of peroxydisulfuric acid ([(HO)S(O)₂]₂O₂), and/or polymeric reaction products with tetrasodium ethenylidenebis[phosphonate]. One non-limiting example of a “modified acrylic acid polymers” is 2-propenoic acid, polymer with sodium phosphinate (1:1).

The above zinc sulfide deposition preventers are known ZnS dispersants. However, it was discovered that certain ZnS dispersants did not significantly affect the formation of ZnS solids. These include, but are not necessarily limited to, mixtures of a phosphonate salt with a quaternary ammonium compound, as well as the phosphonate salt or the quaternary ammonium compound used separately.

With respect to the amount of zinc-based sulfur compound scavenger effective to scavenge sulfides from the fluid, the amount ranges from about 0.25 independently to about 50 parts zinc to 1 part of the total of sulfur compound, where it is remembered that the sulfur compound is H₂S/sulfide/bisulfide in the brine and/or hydrocarbon phase, understanding that the about of sulfide will vary and the amount of zinc in the scavenger will also vary. In this context of amounts, “zinc” refers to the zinc portion of the zinc-based sulfur compound scavenger. In a different non-restrictive version, the effective amount of scavenger may range from about 0.5 parts independently to about 20 parts zinc to parts H₂S/sulfide/bisulfide. As used herein with respect to a range, the term “independently” means that any threshold may be used together with any other threshold to give a suitable alternative range. In a non-limiting example in this case, a suitable alternative range can be 20 parts to 50 parts zinc to sulfide compound.

The amount of zinc sulfide deposition preventer effective to prevent or inhibit ZnS solid formation ranges from about 0.1 parts independently to about 50 parts zinc sulfide deposition preventer to parts zinc-based sulfur compound scavenger; alternatively from about 0.25 parts independently to about 10 parts zinc sulfide deposition preventer to zinc-based sulfur compound scavenger.

The method described herein is expected to be largely unaffected by pressure and temperature. The method is expected to work at potential production temperatures; in one non-limiting embodiment from about 0° ° C. to about 200° C.

The mechanism by which the zinc sulfide deposition preventer operates to prevent or inhibit ZnS formation and deposition could be either through dispersion, inhibition, and/or dissolution of ZnS; although the method is not limited by any particular mechanism.

The zinc-based sulfur compound scavengers described herein are very effective and react very quickly. In applications with very short contact times, they are often the only viable option. The methods described herein can alleviate or eliminate a main drawback of using zinc-based sulfur compound scavenger, namely insoluble solids formation. And while the zinc sulfide deposition preventers described herein significantly reduce insoluble ZnS in the aqueous phase, the zinc sulfide deposition preventer does not adversely affect the sulfide scavenging performance of the scavenger.

The method and compositions described herein will now be discussed with reference to certain specific Examples which are intended to further illustrate, but not necessarily limit the method and the compositions.

### Examples 1-10

Table I presents the performance in a modified ASTM D5705 test at 49° C., with a two-hour test duration in 70 vol % hydrocarbon/30 vol % brine, where the baseline H₂S content was 5000 ppm. The incumbent was a zinc-based sulfur compound scavenger that was approximately 69.6% zinc, 2-ethylhexanoate neodecanoate complexes where the balance was mostly hydrocarbon solvents with approximately 3.2% 2-butoxyethanol. The New zinc-based sulfur compound scavenger is tetramine zinc (2+) carbonate.

TABLE I
H₂S Scavenging Test Results

| | | Dosage, | % H₂S |
|---|---|---|---|
| Ex. | Scavenger | ppm | Scavenging |
| 1 | Incumbent 1 [HSO3518] | 300 | <60 |
| 2 | Incumbent 1 | 500 | 86 |
| 3 | Incumbent 1 | 700 | 100 |
| 4 | New Scavenger [HSW810] | 300 | <60 |
| 5 | New Scavenger | 500 | 90 |
| 6 | New Scavenger | 700 | 100 |

Field testing was performed with bottles containing multiphase samples taken from a well separator. The test bottles contained 50 vol % water and 50 vol % crude oil. After dosing, the bottles were vigorously hand-shaken individually, and then the headspace H₂S was measured immediately thereby providing a very short contact time. After headspace H₂S measurements, samples were again shaken vigorously by hand and observed for emulsion tendencies over time. The scavenging test results indicated that the New scavenger performed as well as or slightly better than Incumbent 1, but the New scavenger was still able to scavenge H₂S more thoroughly in the tested dosage range, as shown in Table II, where the amounts reported in ppm is the amount of H₂S measured in the head space at the given concentration of scavenger.

TABLE II
H₂S Scavenging Field Test Results

| Ex. | 7 | 8 | 9 |
|---|---|---|---|
| Chemical | Blank | New | Incumbent 1 |
| Concentration | | scavenger | |
| 100 ppm | 800 ppm | 225 ppm | 425 ppm |
| 500 ppm | | 0 ppm | 0 ppm |

The New scavenger did not have the same emulsion tendency as Incumbent 1. The emulsion observed was no worse than the untreated sample. The only issue observed was the formation of reaction products (ZnS) in the water phase, which could present issues depending on where the ZnS deposits.

### Examples 10-17

Two scale inhibitors were evaluated for possible mitigation of ZnS solids: SI 1 and SI 2. Based on expert recommendation from scale inhibition subject matter experts, the minimum dosage for SI 1 was 500 ppm, the minimum dosage for SI 2 was 50 ppm. Performance was measured using a modified ASTM D5705 test at 49° C., two-hour test duration, with a mixture of 70 vol % hydrocarbon/30 vol % brine. It was found that there was no impact of the ZnS deposition preventer on the New scavenger scavenging performance.

TABLE III
Evaluation of ZnS Inhibitor and Dispersant

| | H₂S | Dosage | H₂S %, | % |
|---|---|---|---|---|
| Ex. | Scavenger + SI | (ppm) | ppm | Scavenged |
| 10 | Untreated | | 2500 | |
| 11 | New Scvngr. | 700 | 0 | 100 |
| 12 | New Scvngr. + SI 1 | 700 + 500 | 0 | 100 |
| 13 | New Scvngr. + SI 1 | 700 + 1000 | 0 | 100 |
| 14 | New Scvngr. + SI 2 | 700 + 100 | 0 | 100 |
| 15 | New Scvngr. + SI 2 | 700 + 200 | 0 | 100 |
| 16 | New Scvngr. + SI 2 | 700 + 500 | 0 | 100 |
| 17 | New Scvngr. + SI 2 | 700 + 1000 | 0 | 100 |

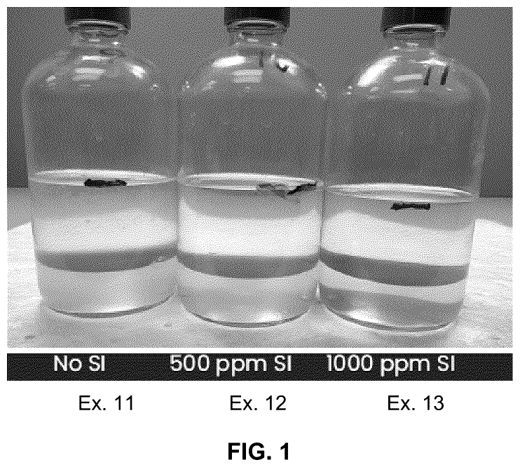

Zinc sulfide dispersant SI 2 did not have a significant effect on ZnS solids formation in the water phase even at dosages up to 1000 ppm. However, at the higher dose tested, SI 1 appeared to significantly reduce insoluble ZnS in the aqueous phase as shown in FIG. 1, which is a photograph of the three bottles of Example 11 which contained no zinc sulfide deposition preventer, the bottle of Example 12 which contained 500 ppm zinc sulfide deposition preventer, and the bottle of Example 13 which contained 1000 ppm zinc sulfide deposition preventer. All bottles contained 700 ppm of the New scavenger. It may be seen from FIG. 1 that at 1000 pm of SI 1 there are no ZnS deposits.

In the foregoing specification, the method has been described with reference to specific embodiments thereof and has been shown as effective in providing a method for inhibiting or preventing ZnS deposition when using a zinc-based sulfur compound scavenger.

It will be evident that various modifications and changes can be made to the methods and compositions described herein without departing from the broader scope of the invention as set forth in the appended claims. Accordingly, the specification is to be regarded in an illustrative rather than a restrictive sense. For example, specific zinc-based sulfur compound scavengers, zinc sulfide deposition preventers, sulfide compounds, fluids, hydrocarbons, waters, ratios, dosages, orders of addition, proportions, and time periods thereof falling within the claimed parameters, but not specifically identified or tried in a particular method or composition to prevent or inhibit the formation of ZnS, are expected to be within the scope of this application.

The present application may suitably comprise, consist, or consist essentially of the elements disclosed and may be practiced in the absence of an element not disclosed. For instance, there may be provided a method for scavenging a sulfur compound from a fluid comprising a hydrocarbon, water, and the sulfur compound selected from the group consisting of H₂S, sulfide, bisulfide, and combinations thereof, where the method comprises, consists essentially of, or consists of injecting at least one zinc-based sulfur compound scavenger into the fluid in an amount effective to at least partially scavenge the sulfur compound from the fluid, injecting at least one zinc sulfide deposition preventer into the fluid in an amount effective to at least partially prevent the deposition of zinc sulfide from the fluid, where injecting the at least one zinc-based sulfur compound scavenger and injecting at least one zinc sulfide deposition preventer occurs in any order or simultaneously.

Further there may be provided a sulfur compound scavenged fluid comprising, consisting essentially of, or consisting of a hydrocarbon; water; the sulfur compound selected from the group consisting of H₂S, sulfide, bisulfide, and combinations thereof; at least one zinc-based sulfur compound scavenger in an amount effective to at least partially scavenge the sulfur compound from the fluid; at least one zinc sulfide deposition preventer into the fluid in an amount effective to at least partially prevent the deposition of zinc sulfide from the fluid.

As used herein, the terms “comprising,” “including,” “containing,” “characterized by,” and grammatical equivalents thereof are inclusive or open-ended terms that do not exclude additional, unrecited elements or method acts, but also include the more restrictive terms “consisting of” and “consisting essentially of” and grammatical equivalents thereof. As used herein, the term “may” with respect to a material, structure, feature, or method act indicates that such is contemplated for use in implementation of an embodiment of the disclosure and such term is used in preference to the more restrictive term “is” so as to avoid any implication that other, compatible materials, structures, features, and methods usable in combination therewith should or must be, excluded.

As used herein, the singular forms “a,” “an,” and “the” are intended to include the plural forms as well, unless the context clearly indicates otherwise.

As used herein, the term “and/or” includes any and all combinations of one or more of the associated listed items.

As used herein, relational terms, such as “first,” “second,” “top,” “bottom,” “upper,” “lower,” “over,” “under,” etc., are used for clarity and convenience in understanding the disclosure and do not connote or depend on any specific preference, orientation, or order, except where the context clearly indicates otherwise.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” in reference to a given parameter is inclusive of the stated value and has the meaning dictated by the context (e.g., it includes the degree of error associated with measurement of the given parameter).

What is claimed is:

1. A method for scavenging a sulfur compound from a fluid comprising a hydrocarbon, water, and the sulfur compound selected from the group consisting of H₂S, sulfide, bisulfide, and combinations thereof, the method comprising:
injecting at least one zinc-based sulfur compound scavenger into the fluid in an amount effective to at least partially scavenge the sulfur compound from the fluid; and
injecting at least one zinc sulfide deposition preventer into the fluid in an amount effective to at least partially prevent the deposition of zinc sulfide from the fluid;
where injecting the at least one zinc-based sulfur compound scavenger and injecting at least one zinc sulfide deposition preventer occurs in any order or simultaneously.

2. The method of claim 1 where the fluid is a mixed production fluid, where the hydrocarbon is crude oil, and where the water is selected from the group consisting of fresh water, brine, and combinations thereof.

3. The method of claim 1 where the at least one zinc-based sulfur compound scavenger is selected from the group consisting of a zinc carboxylate, a tetramine zinc carbonate, a zinc carbonate, a zinc ammonium carbonate, a zinc chelate, a zinc lignosulfonate, and combinations thereof.

4. The method of claim 1 where the at least one zinc sulfide deposition preventer is selected from the group consisting of sodium salts of a phosphorous-based polymer, polymeric ammonium salts, acrylic sulfonate non-ionic terpolymers, modified acrylic acid polymers, and combinations thereof.

5. The method of claim 1 where the effective amount of the at least one zinc-based sulfur compound scavenger ranges from about 0.25 to about 50 parts zinc to 1 part of the total of sulfur compound.

6. The method of claim 5 where the effective amount of the at least one zinc sulfide deposition preventer ranges from about 0.1 to about 50 parts zinc sulfide deposition preventer to parts zinc-based sulfur compound scavenger.

7. The method of claim 1 where the sulfur compound comprises H₂S.

8. A method for scavenging a sulfur compound from a fluid comprising a hydrocarbon, water, and the sulfur compound selected from the group consisting of H₂S, sulfide, bisulfide, and combinations thereof, the method comprising:
injecting at least one zinc-based sulfur compound scavenger into the fluid in an amount effective to at least partially scavenge the sulfur compound from the fluid, where the at least one zinc-based sulfur compound scavenger is selected from the group consisting of a zinc carboxylate, a tetramine zinc carbonate, a zinc carbonate, a zinc ammonium carbonate, a zinc chelate, a zinc lignosulfonate, and combinations thereof; and
injecting at least one zinc sulfide deposition preventer into the fluid in an amount effective to at least partially prevent the deposition of zinc sulfide from the fluid, where the at least one zinc sulfide deposition preventer is selected from the group consisting of sodium salts of a phosphorous-based polymer, polymeric ammonium salts, acrylic sulfonate non-ionic terpolymers, modified acrylic acid polymers, and combinations thereof;
where injecting the at least one zinc-based sulfur compound scavenger and injecting at least one zinc sulfide deposition preventer occurs in any order or simultaneously.

9. The method of claim 8 where the fluid is a mixed production fluid, where the hydrocarbon is crude oil, and where the water is selected from the group consisting of fresh water, brine, and combinations thereof.

10. The method of claim 8 where the effective amount of the at least one zinc-based sulfur compound scavenger ranges from about 0.25 to about 50 parts zinc to 1 part of the total of sulfur compound.

11. The method of claim 10 where the effective amount of the at least one zinc sulfide deposition preventer ranges from about 0.1 to about 50 parts zinc sulfide deposition preventer to parts zinc-based sulfur compound scavenger.

12. The method of claim 8 where the sulfur compound comprises H₂S.

13. A sulfur compound scavenged fluid comprising:
a hydrocarbon;
water;
the sulfur compound selected from the group consisting of H₂S, sulfide, bisulfide, and combinations thereof;
at least one zinc-based sulfur compound scavenger in an amount effective to at least partially scavenge the sulfur compound from the fluid; and
at least one zinc sulfide deposition preventer into the fluid in an amount effective to at least partially prevent the deposition of zinc sulfide from the fluid.

14. The sulfur compound scavenged fluid of claim 13 where the hydrocarbon is crude oil, and where the water is selected from the group consisting of fresh water, brine, and combinations thereof.

15. The sulfur compound scavenged fluid of claim 13 where the at least one zinc-based sulfur compound scavenger is selected from the group consisting of a zinc carboxylate, a tetramine zinc carbonate, a zinc carbonate, a zinc ammonium carbonate, a zinc chelates, a zinc lignosulfonate, and combinations thereof.

16. The sulfur compound scavenged fluid of claim 13 where the at least one zinc sulfide deposition preventer is selected from the group consisting of sodium salts of a phosphorous-based polymer, polymeric ammonium salts, acrylic sulfonate non-ionic terpolymers, modified acrylic acid polymers, and combinations thereof.

17. The sulfur compound scavenged fluid of claim 13 where the effective amount of the at least one zinc-based sulfur compound scavenger ranges from about 0.25 to about 50 parts zinc to 1 part of the total of sulfur compound.

18. The sulfur compound scavenged fluid of claim 17 where the effective amount of the at least one zinc sulfide deposition preventer ranges from about 0.1 to about 50 parts zinc sulfide deposition preventer to parts zinc-based sulfur compound scavenger.

19. The sulfur compound scavenged fluid of claim 13 where the sulfur compound comprises H₂S.
